(19) United States
(12) Patent Application Publication
(10) Pub. No.: US 2023/0419372 A1
(43) Pub. Date: Dec. 28, 2023

(54) Get Out and Experience

(71) Applicants: David Jeffrey Sapp, Lakeview, MI (US); Richard Karl Boomer, Lakeview, MI (US); Mitchell Ridge Chapman, Kalamazoo, MI (US)

(72) Inventors: David Jeffrey Sapp, Lakeview, MI (US); Richard Karl Boomer, Lakeview, MI (US); Mitchell Ridge Chapman, Kalamazoo, MI (US)

(21) Appl. No.: 17/847,207

(22) Filed: Jun. 23, 2022

(51) Int. Cl. G06Q 30/02; G06Q 50/00

(52) U.S. Cl. CPC G06Q 30/0282; G06Q 30/0205; G06Q 30/0226; G06Q 50/01

(57) ABSTRACT

A method of online event selection system incorporating a user terminal, server where the user is required to make an account distinguishing on the basis of location via location service function enabled and or user input. In the further embodiment of the invention, the system provides an interactive display allowing members to see the most populated social venues, events, and or location; in any given location with multiple novel features including but not limited to point system, allocation of points to users and locking of events for the user.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights, whatsoever.

### BACKGROUND

### Field of the Invention

This invention relates in general to user facilitation and in particular to mobile and desktop application and optimization systems, methods and apparatuses. The present invention relates to an electronic online community and, more particularly to, the intelligent information gathering, organization and display of venues and or events within the user vicinity and their feedback on them with unique point system, reward system and event locking system.

### Description of the Related Art

Times have changed. There is a need to facilitate and ease the processes in a new era of ever-growing population and information where time is precious. The experience of real face-to-face interaction is often missing. Technology has to emulate components of real experiences and human factors in order for users to be fully satisfied.

Social media systems, websites, and networks have enjoyed tremendous popularity over the past several years. Herein, social media systems, social media websites, and social media networks, regardless of distribution and/or access means, are collectively referred to as “social media systems”. Herein, social media systems include, but are not limited to, computing system implemented networks, systems, and sites that allow users to provide content, often in the form of posts, about themselves and to track and view posts from selected other users of the social media system.

Specific examples of currently available social media systems include but are not limited to: Facebook™; Twitter™; Linkedin™; Bebo™; Classmates.com™; Google Buzz™; MySpace™; and many other post, blogging, and user content provided, websites/networks as discussed herein, and/or as known in the art at the time of filing, and/or as developed after the time of filing.

A relatively new, and very popular, feature associated with social media systems is the “user location update” feature whereby a user can inform their friends/follows of their location thru semi-automatically, or automatically, generated posts indicating the user's location, and/or the business associated with that location. A specific illustrative example of a user location update feature is the “check-in” feature currently provided within the Facebook™ social media system.

The user location update feature has proven popular and useful not only to let a user's friends know where the user is located, but also to learn if the user's friends are nearby at the same time. One of the key attributes that has contributed to the popularity and usefulness of the user location update feature is usefulness for user to find out the venues, events and happenings in their vicinity. Regardless of whether the user is single, coupled, married or with children; they want to gain the knowledge of popular places around them and what are people experiences on them. There are multiple inventions that have been presented in prior art regarding use of internet to promote the social media activities.

For instance, a method, medium, and system for adjusting a selectable element based on social networking usage bearing U.S. Pat. No. 8,355,955B1 is issued to Amazon Technologies Inc. The patent discloses systems and methods are disclosed that use social networking profiles of users to generate personalized content of display pages. The personalized content may be generated using profile data retrieved via an application program interface of a social networking system and may be presented on the display pages of a distinct system, such as a site that hosts an electronic catalog of items. The personalized content may include features that allow a user to indicate a like or preference for an item and that can be customized based on, e.g., the extent of the user's social network or the influence the user has over other potential users of the catalog system. Systems and methods are also disclosed that use the social networking profiles to generate personalized messages that can be posted to social network contacts of the user to provide information about items for which the contacts may be interested.

A System and Method for Creating and Sharing an Event Using a Social Network bearing US patent 2,012,000,4956A1 is issued to Charles D. Huston, Chris Coleman. The patent discloses a system and method for creating and viewing artificial reality (AR) messages at an event, such as a sporting event, and sharing the event on a social network thereby enhancing and expanding the participant and spectator experience. The AR messages include geo-referenced artificial reality words or symbols to indicate distances, tips, targets or other information to the participant. The event is shared with spectators, such as friends or a subset of friends in the participant's social network. In addition to creating an active gallery for an event, messages can be exchanged among participants and spectators and virtual goods, money, and donations exchanged.

A user contribution-based mapping system and method bearing US patent 2,012,0135,756A1 is issued to Location Labs Inc. The patent discloses a computer-implemented user contribution method is provided. The method includes retrieving event data posted by a plurality of users related to a first user, the event data including indications of at least one geographic area. The event data is compared with predetermined trigger data. A quality value of the at least one geographic area is determined based on the comparison of the event data with predetermined trigger data, and an indication of the quality value of the at least one geographic area is transmitted to a second user. A user contribution-based mapping system is further provided.

A System and method for providing mobile alerts to members of a social network bearing US patent 2,013,013,7464A1 is issued to Groupon Inc. The patent discloses systems and methods are presented for providing mobile alerts to members of a social network upon the occurrence of certain trigger events related to the social network, including member-trigger events, venue-trigger events, and other-trigger events. A member may select and edit their own mobile-alert settings that determine which events are trigger events. The member may enable or disable all their mobile alerts using a single action, such as toggling a digital button on their phone screen. A data processor receives indication of, or determines occurrence of, a trigger event. The data processor then determines whether to communicate a mobile alert to the member based on the member's mobile-alert settings. The alert may be communicated to the member's mobile communication device, such as a mobile phone, using a variety of convenient means, such as a text message or Push Notification.

A Method and system for automatically generating event relevant marketing devices bearing US patent 2,012,018,5309A1 is issued to Intuit Inc. The patent discloses a method and system for automatically generating event relevant marketing devices whereby events data is obtained from one or more sources that indicates upcoming events of interest to a merchant. Offer data to be associated with a marketing device is obtained from the merchant. The offer data, and/or the merchant submitting the offer data, indicates the merchant, and/or services offered by merchant, and/or products offered by merchant. The offer data is then mapped to one or more event types using a merchant/product/service type-to-event type mapping system and the events data is searched to identify a relevant event represented by the events data that is of the event type mapped to the offer data. The offer data and the portion of the events data representing the identified relevant event is then “matched” and used to automatically generate one or more event relevant marketing devices that include at least part of the matched offer data and at least part of the matched relevant event data.

Another invention focused on capturing structured data about previous events from users of a social networking system bearing U.S. Pat. No. 8,887,035B2 is issued to Facebook Inc. The invention provides a display interface in a social networking system that enables the presentation of information related to a user in a timeline or map view. The system accesses information about a user of a social networking system, including both data about the user and social network activities related to the user. The system then selects one or more of these pieces of data and/or activities from a certain time period and gathers them into timeline units based on their relatedness and their relevance to users. These timeline units are ranked by relevance to the user and are used to generate a timeline or map view for the user containing visual representations of the timeline units organized by location or time. The timeline or map view is then provided to other users of the social networking system that wish to view information about the user.

An event analysis and tagging system bearing US patent 2,016,029,2881A1 is issued to Blast Motion Inc. The patent discloses a system that analyzes data from sensors and video cameras to generated synchronized event videos and to automatically select or generate tags for an event. Enables creating, transferring, obtaining, and storing concise event videos generally without non-event video. Events stored in the database identifies trends, correlations, models, and patterns in event data. Tags may represent for example activity types, players, performance levels, or scoring results. The system may analyze social media postings to confirm or augment event tags. Users may filter and analyze saved events based on the assigned tags. The system may create highlight and fail reels filtered by metrics and by tags.

A Method and system for automatically adding related event information to social media location updates bearing U.S. Pat. No. 8,611,929B1 is issued to Intuit Inc. The patent discloses a process for automatically adding related event information to social media location updates integrates one or more event data sources into the social media location update process and thereby provides the ability to automatically identify events associated with the identified location of a social media location update and automatically include information describing the identified event in a social media location and event update posting.

The current invention proposes to provide a system that focuses on social media to create real life interactions. It displays location-based venues including but not limited to clubs, bars, parks, restaurants and displays what is most popular, per users' feedback. The application provides overall point and review system, the locking in features and swipe-based event selection and locking system.

The invention allows members to see the most populated social areas or venues, in any given location, in real time. The application will be interactive allowing user to adjust radius of interest, search a specific place of interest, plan their time according to events and or correspondence with favorites, which must be approved by the requested favorite. Users may rate locations/venues and leave a short review of 100 characters of less for other members to see before visiting. Additionally, users may view pictures and or profiles of users within their location of interest. The application aims to add multiple businesses to pay a monthly fee to create an event and publish for people to join.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, and abstract as a whole.

It is therefore the purpose of the invention to alleviate at least to some extent one or more of the aforementioned problems of the prior art and/or to provide the relevant public with a suitable alternative thereto having relative advantages.

It is the general object of this invention to provide a new and improved online portal for assisting customers in acquiring the information of events or happenings at their desired locality.

It is the object of current invention to provide a point system which works as such; events are worth a certain number of points based on the overall reviews the business gets from customers.

It is further the object of current invention to provide an online application which allows users to be rewarded with the number of points the event worth for, once the QR code is scanned successfully by the individual.

It is also the object of the invention to provide users with lock functionality where user can lock the event and will lose or gain points on its basis. The user will not be shown any other event for that day.

Moreover, it is the object of current invention to provide an active system where users can get interactive display, allowing user to adjust radius of interest, search a specific place of interest, plan their leisure time according to events and or correspond with favorites.

Moreover, it is the objective of current invention, to provide user an opportunity to leave a review regarding the venue, event, and or location; for other members to see before visiting.

Still yet a further object of the present invention is to provide a method and system for businesses to pay a monthly fee to create an event and publish for people to join. Each business will be given a corresponding QR code that users can scan when they attend an event to verify that they attended, and receive their points.

It is the object of current invention to provide an application which has a simple interface and is compatible with IOS and Android phones.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

Further, although the embodiment is described as including a number of functions, aspects of the embodiment do not require all of these functions. Rather, it should be borne in mind that there are many aspects of the embodiment that are formed using only one or a small subset of all the functions described.

In addition, the discussion of the embodiment is in the context of a website which represents one way the system could be implemented. However, the system could be implemented using different technologies and still provides its users with the same and or similar functionality.

Briefly, the present invention includes a method for online community system where users can locate the events/happenings around them or their preference areas and get the insight of event. It is preferred for the application of the invention to be installed upon the user's ‘mobile device’ to run constantly as a background task with location services enabled. This appeal extends to the service providers that provide the services accessed via background mobile applications and or desktop, who benefit from the user's perceived commitment to those services in terms of advertising effectiveness, community-building and so on.

The method and procedure in its current domain allows the user to reach the website/application through a mobile or laptop or smart devices and then make an account as a user. The enabling of ‘location services’ of the user is a necessary requirement to create an account. The website allows users to create a private space where, based on location, the user may access the event information happening within their chosen range of physical proximity around him/her.

The invention allows direct link between a user and venue, event, and or location details thus alerting the users with real time alerts and information as a display. This direct link also means that it is possible to see the details of the attendees at their choice of venue, event, and or location and get the real time information of the attendees.

The input from the user is devised from user terminals which may comprise Internet terminals with keyboards as one skilled in the art would recognize. A user may enter their pre-requirements into the interactive system through a user terminal, which transmits the data to the server. As it receives request from user terminals, the system prioritizes the request and search for the events happening in the required vicinity. The system determines continuing priority for providing an ongoing service to the user.

User computers 102-106 represent the computers of users of the system of the present invention. There can be any number of such computers. These could be any type of device that would allow the user to connect to server 110 via computer network 108, send and receive data to and from server 110, and process that data appropriately. For example, if server 110 is a web server, computer 102 could be personal computer or mobile device running a web browser. User computers 102-106, then, represent all possible systems that users might use to communicate with server 110.

The user must sign up for a membership, filling out a brief form containing the necessary fields of data and a user account is immediately created or can be done via the means of connecting with another social media platform. Specification of geographical area represents a system by which the user can specify the geographical area under consideration for his purposes at the time he is using the system and/or particular functions of the system. If the user specifies a geographical area, the content and/or functionality of the system can be modified or extended to reflect that area. Search display on the user screen provides search function which allows the user to search the content of the embodiment. The search query can reflect (instead of or in addition to content from around the Internet) the content and/or functionality of any combination of one or more venue, event, and or location; locally or individually or privately or on open invitation.

The system as per its further embodiments provides unique point system. The point system works in a way where events are worth a certain number of points based on the overall reviews the business gets from customers. For instance, a 5-star business bears 150 points, 4-star business bears 100 points, 3-star business bears 75 points, 2-star business bears 50 points, and a 1 star-business bears 25 points. Business will strive for high reviews in order for their events to be worth more points.

The system as per its further embodiments provides system for points to affects the users. When users go to these events and punch their attendance with the QR code system, the user profile will be rewarded the number of points that the event is worth. Likewise, if users fail to attend the events, their profiles are then deducted the points the event was worth.

The system as per its further embodiments provides system for locking the event. This involves users to swipe up on one event for a particular day and time. When users “lock in” to an event they cannot swipe up for any other event that would interfere with an event they have already decided to go to. They are also unable to back out of the event. Once they lock in, they must attend and gain points, or not attend and lose points.

The system also aims to provide business feature which allows businesses to enroll and register their events. The businesses can pay a monthly fee to create an event and publish for people to join. Each business will be given a corresponding QR code that users can scan when they attend an event to verify that they attended, and receive their points. Any tickets purchased from businesses through the app will have a QR code that the business can scan to log the ticket when someone is being admitted inside the event.

The system can be viewed and used from a personal computer, laptop, PDA or any computing device. In order to use the web-based application, the user has to be connected to internet to provide the feedback in real time. For real time utility needs to be connected to internet through local area networks (“LANs”)/wide area networks (“WANs”), wireless network or independent internet source. Further, the internet would connect the user to the online feedback application server, through the user's computing or mobile device, where applicable.

Generally, client device may include virtually any computing device capable of receiving and sending a message over a network, such as LAN/WAN or independent network, wireless network, and the like, to and from another computing device, such as server or mobile device, and the like. The set of such devices may include devices that typically connect using a wired communications medium such as personal computers, multiprocessor systems, microprocessor-based or programmable consumer electronics, network PCs, and the like. The set of such devices may also include devices that typically connect using a wireless communications medium such as cell phones, smart phones, Tablets or PDAs. Similarly, client device may be any device that is capable of connecting using a wired or wireless communication medium such as a PDA, POCKET PC, wearable computer, and any other device that is equipped to communicate over a wired and/or wireless communication medium.

Client device may include a browser application that is configured to receive and to send web pages, web-based messages, and the like. The browser application may be configured to receive and display graphics, text, multimedia, and the like, employing virtually any web-based language, including Standard Generalized Markup Language (SMGL), HyperText Markup Language (HTML), and so forth.

Client device may also include mobile computing devices especially the smartphone, which allow the user to download the application and use it on one click. The online website has a responsiveness mode for the application to function in full on the mobile computing device. Any mobile computing device can be used by the user for using the application. Such devices include portable devices such as, cellular telephones, smart phones, Personal Digital Assistants (PDAs), handheld computers, wearable computers, tablet computers, integrated devices combining one or more of the preceding devices, and the like.

The online feedback application is available through a website and also through an app on the android platform. The application can be downloaded easily free of cost from Google Play store. The application is also available on iOS system by Apple.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

We claim:

I: A method of an online and dynamic venue, event, and or location attending system comprising:
(a) a website/application to display on the user's output screen,
(b) providing an end user interface on the user's device,
(c) providing said website for running on mobile devices, laptops or desktop screen,
(d) a user terminal,
(d) means for collecting information especially via enabled location services from said end user by a display of one or more screens of selectable information at the beginning of execution of the application,
(e) whereby said website will collect demographic information directly from said end user.

II: The method of claim 1; further including means for saving the collected information on said mobile device, desktop or laptop and transmitting this information to receiving server.

III: The method of claim 1; used so that the collected demographic information are to be used specifically for targeting a specific set of users.

IV: The method of claim 1; used so that the user is connected to the venue, event, and or location happening at their current or otherwise specified locality.

V: The method of claim 1; presenting a unique point system allowing to award points to events. These points are based on reviews gathered by businesses on their past events.

VI: The method of claim 1; allowing to award points to users once they attend the event. The user can scam the QR code to mark their attendance and get the associated points added to their profiles.

VII: The method of claim 1; providing application where users can swipe up on one event for a particular day and time. When users “lock in” to an event they cannot swipe up for any other event that would interfere with an event they have already decided.

VIII: The method of claim 1; allowing businesses to register and business will be given a corresponding QR code that users can scan when they attend an event to verify that they attended, and receive their points. The tickets purchased from businesses through the app will have a QR code that the business can scan to log the ticket when someone is being admitted inside the event.
